(19) United States
(12) Patent Application Publication
(10) Pub. No.: US 2008/0236414 A1
(43) Pub. Date: Oct. 2, 2008

(54) Apparatus for Pad Printing of Products Having Significant Variations and Process Therefor

(76) Inventor: Laurent De Volder, Maria-Aalter (BE)

Correspondence Address: Lipsitz & McAllister, LLC, 755 MAIN STREET, MONROE, CT, 06468, US

(21) Appl. No.: 10/594,353

(22) PCT Filed: Mar. 29, 2005
(86) PCT No.: PCT/BE2005/000042

§ 371 Date: Sep. 26, 2006

(30) Foreign Application Priority Data
Mar. 26, 2004 (BE) 2004-0161

(51) Int. Cl. B41F 17/00

(52) U.S. Cl. 101/41

(57) ABSTRACT

A device for printing products with significant variations between them by means of a pad (24, . . . , 84), in particular for confectionery, sugared almonds, chocolates and pharmaceutical tablets comprising at least one pad (24, . . . , 84) with a primary guide (25, . . . , 85) provided for the main movement of the pad (24, . . . , 84), which provides for a movement function, remarkable in that at least one secondary guide (26, . . . , 86; 27, . . . , 87) is provided as buffer element for buffering the differences in effective deposit depth between the individual products to be printed (23, . . . , 83).

### FIELD OF THE INVENTION

This invention relates to a device for printing products with significant variations between them by means of pad printing, in particular for confectionery, sugared almonds, chocolates and pharmaceutical tablets.

The product variations in this case include not only the natural product variations within the same production series, but also the possible variations between successive series of products to be printed with the same machine.

### PRIOR ART

It is known that every device employs the conventional method for pad printing on the basis of so-called linear pad printing. After the setting of the printing parameters, including uptake depth, deposit depth, choice of the pad, inter alia as regards shape, size and hardness, and choice of the ink, inter alia as regards medium, pigments, drying characteristics and adhesion characteristics, the products are printed according to the sequence of selective application of ink to a flat plate or cliché, followed by the uptake of the ink by means of the pad so that, finally, the ink is deposited directly by rolling the pad over the product without intermediate steps. The printing parameters are optimized here for a series of products to be printed.

A problem that occurs here is that individual product variations cannot be compensated for by means of the existing methods. In fact, uptake depths and deposit depths in particular are set for a whole series of products, and not for products individually if it is a matter of relatively small-scale products of the type referred to above.

Conventional machines operating on the basis of a method using linear pad printing therefore do not permit the printing of products with a guarantee of product quality in the case of series with great product variation between them. The quality of the product can be damaged by an unacceptable printing quality or by damage to the product because of the parameters of the machine being adjusted to a lower than optimum setting for a variable set of product parameters. The nature and gravity of the product quality damage depends on the product in question. It can be considerable, in particular for products such as confectionery, sugared almonds, chocolates and pharmaceutical tablets, which then inevitably leads to great product waste, up to inadmissible levels.

In the case of the abovementioned known conventional machines for printing products by means of linear pad printing the limitations in the case of significant product variations between the production series are summarized below.

The machine parameters such as image size, position of the image relative to the product, printing parameters of the ink, including medium, pigment, drying time, adhesion etc., and the size and shape of the pad, its hardness, the uptake depth on the cliché and the deposit depth on the product are in each case set for a set of products.

In addition, during the setting of the parameters of the machine, account can be taken of only slight deviations of the products and/or of the inaccuracies in the positioning of the product relative to the printing unit. In the case of a conventional pad printing machine it is not possible to adapt the machine parameters to the effective individual characteristics of the product such as shape, size, color, surface characteristics etc. All this results in a reduction in the average product quality in the case of products with considerable product variations between them, as a result of product damage, in particular deformation as a result of a too great pressure force on the product, on the one hand, and loss in quality of the printing as regards image, position, intensity and color(s), inter alia, on the other hand.

Eliminating these abovementioned limitations calls for a technological solution that cannot be reached in devices that employ the conventional method of pad printing.

### OBJECT OF THE INVENTION

The object of the invention is to avoid damage to the quality of the end product during printing. To this end, one or more of the following measures must be taken as a solution to the problems and shortcomings of the existing systems, depending on the degree of product variation and the specific individual character of the products to be printed.

### SUMMARY OF THE INVENTION

According to the invention, an adapted printing unit of the type further defined in the main claim is therefore proposed, wherein the pressure on the products to be printed is limited in the case of products with significant product variations between them, by an adapted method, likewise defined in the subclaims, and by a device.

According to a preferred embodiment of the invention, an adapted piece holder for the product is further proposed, wherein the position and orientation of the product relative to the printing unit is brought into line with the one, which is necessary for printing the image at the envisaged position on the product. This means that undesirable friction between product and environment is reduced as much as possible, or even eliminated.

According to an additional preferred embodiment of the invention, conditioning of the product and the environment is proposed, in this case the piece holder for the product, with regard to temperature, pressure, humidity etc., in order to eliminate product damage arising from not conditioning the environment.

According to a further preferred embodiment of the invention, conditioning of the substance to be printed on the product, such as ink, chocolate and the like, with regard to, inter alia, temperature, viscosity and color, is proposed, in order to keep the print quality constant in this way.

According to yet another preferred embodiment of the invention, an adapted device is proposed for the infeed of the product to and discharge of the product from the printing machine, with guarantee of product quality being retained. The fact is that the more fragile the product to be printed, the more complex the infeed and discharge mechanisms will be.

In the abovementioned first case of so-called natural product variations in a particular product series the device according to the invention offers a solution to the printing of the products with the retention of consistent product quality. In the abovementioned second case of possible variations between series of products to be printed with the same machine, the device according to the invention offers a solution that drastically reduces the setting time of the machine and thereby also makes it economically practicable to print small series with significant variation between the products.

Special features of this device are the possibility of integration in automatic or manual machines. The device can also be used for printing these products with several colors and/or on several sides.

Specific embodiments of the device according to the invention are defined in further sub-claims.

The entirety of the claimed features, taken alone or in combination with each other, results in a set of devices that allow products with significant product variations, in particular pharmaceutical tablets and edible products, including chocolate, chocolates and sugared almonds, to be printed in several colors and/or on several sides of the product without loss of product quality. Specific care is always taken here to ensure that the quality of the end product remains guaranteed. Quality in the broad sense is then determined by the retained quality of the product and the quality of the monochrome or multicolor printing, applied on one side or on several sides of the product.

In particular, the following advantages are present compared with the existing devices. According to the invention, a printing device that is adapted to the type of product—partly flexible, but also brittle—is proposed. The device for the pad movement comprises in particular a set of elements that form, respectively in pairs, a double guide with, on the one hand, a primary conventional guide by means of which the main movement of the pad is carried out and, on the other hand, an additional secondary guide for buffering the differences in effective deposit depth between the individual products. This is an essential aspect of the system according to the invention.

Thanks to this specific combination provided in the device according to the invention for the pad movement, consisting of primary elements with a movement function and secondary elements with a buffer function, the pressure force on the product to be printed can be reduced and allowances are made for significant variations in the dimensions of the product. This means that the quality of the products can be guaranteed and a high capacity can be obtained by printing a number of items—with significant variations between them—per printing cycle.

According to a special embodiment of the device according to the invention, the abovementioned secondary elements are formed by elastic elements, preferably of the spring type, which are disposed axially relative to the movement axis of the pad.

According to an additional device for the printing device, the conventional solid pad is replaced by a hollow pad. The shape of the pad and of the hollows, specifically for a particular product and image to be printed, result in a reduction of the pressure force on the product to be printed. This addition is all the more important in the case of great product variations, in combination with a large printed image or otherwise, and the characteristics of the product with regard to deformation.

A combination of the two techniques, double guide and use of hollow pads, can be used for certain combinations of products and printed images. Moreover, these both devices permit simultaneous printing of several products with significant variations between them.

Significant product variations can also be compensated for partly by the abovementioned piece holder. The main advantages of the piece holder, as indicated according to a possible arrangement of it, are the avoidance of local pressure points on the products, during infeed, conveyance, printing and discharge, this being where there are significant variations in the dimensions of the products. The product can also be prevented from undergoing friction as a result of stationary parts during conveyance, which can give rise to product damage.

This device can also be used for certain cases, in combination with one or more of the previous devices or otherwise, as a solution designed to compensate for product variations.

This invention also relates to a method for printing the abovementioned products by means of pad printing, in particular by means of a device according to this invention.

The method according to the invention therefore compensates for significant product variations by dividing up more specifically the printing cycle per se. After the specific measurement of the variable product parameter(s), for example dimensions and shape of the product, the settings of the printing unit are adapted in accordance with the measured characteristics. The individual parameters to be set comprise the uptake depth and deposit depth and also the shape and the effective hardness of the pad. By this method, optimum printing is obtained on an individual product basis.

Further features and characteristics of the invention will be defined in the additional sub-claims.

Further details and particulars of the invention will hereafter be explained with reference to the description hereafter of an exemplary embodiment of the device according to the invention by means of the appended drawings.

### BRIEF DESCRIPTION OF THE FIGURES

FIG. 1 is a diagrammatic view of the roll-over process in the case of linear pad printing.

FIG. 2 is a diagrammatic representation of an embodiment of a part of a device according to the invention comprising an arrangement of a secondary guide and primary pad guide.

FIG. 3 is an analogous representation to that of FIG. 2 of a further embodiment of the device according to the invention comprising a hollow pad guide.

FIG. 4 is a diagrammatic representation of yet a further embodiment of a device according to the invention comprising the abovementioned secondary guide in combination with a hollow pad.

FIG. 5 is a diagrammatic representation of an additional embodiment of the device according to the invention with a piece holder.

FIGS. 6 to 8 show in a diagrammatic manner the various steps of the method according to the invention with variants.

### DESCRIPTION

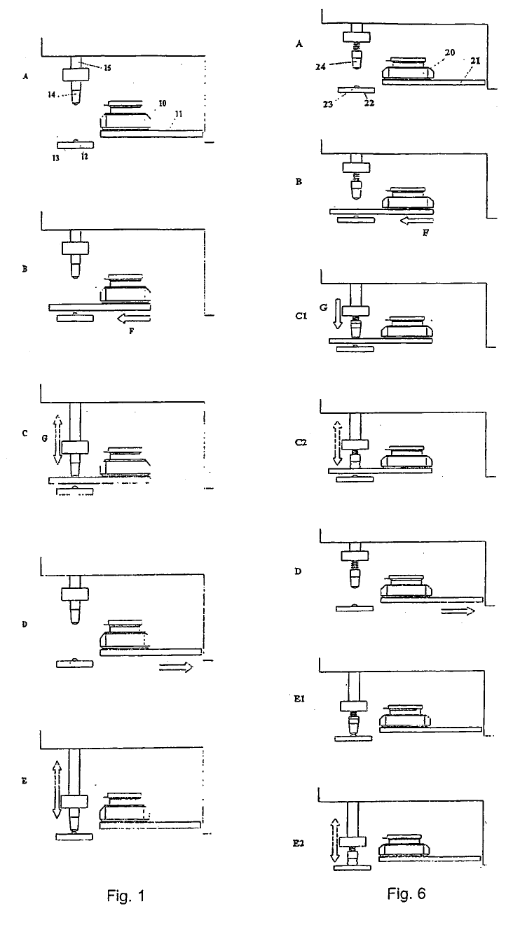

The roll-over process in the case of linear pad printing is shown diagrammatically in FIG. 1.

A printing unit comprising an additional secondary guide 26, 27 which is mounted on a primary pad guide 25 is illustrated in FIG. 2.

FIG. 4 shows a combination of the additional secondary guide 46, 47 with a hollow pad 44. This whole unit is mounted on the primary pad guide 45.

A piece holder which car also be used for compensation for the product variation is shown in FIG. 5. Said piece holder comprises a product mask 59 which prevents the products 53 to be printed from moving too far in the direction of the printing unit. A guide 58 can move the product 53 according to a movement in the direction H of the printing unit.

The various steps of the method are illustrated in FIGS. 6 to 8, in the case of which in the first-mentioned FIG. 6 a single pad system 61 with a primary guide 65, the secondary guide 66 and the single pad 64 is shown.

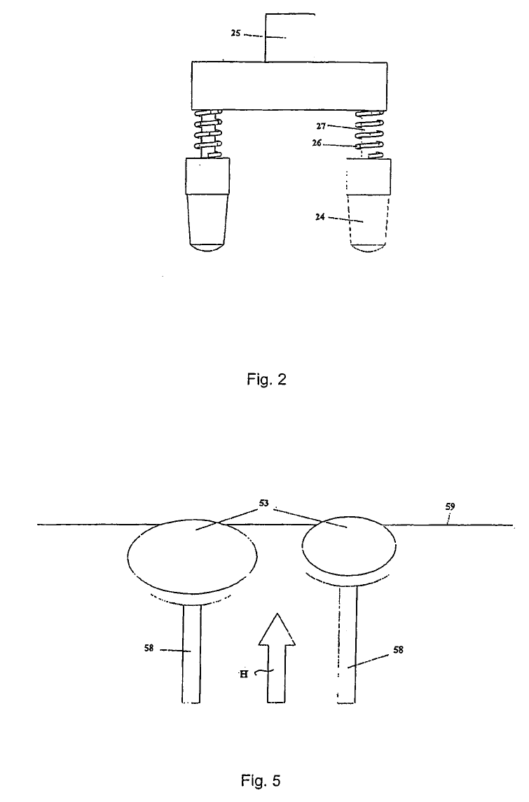

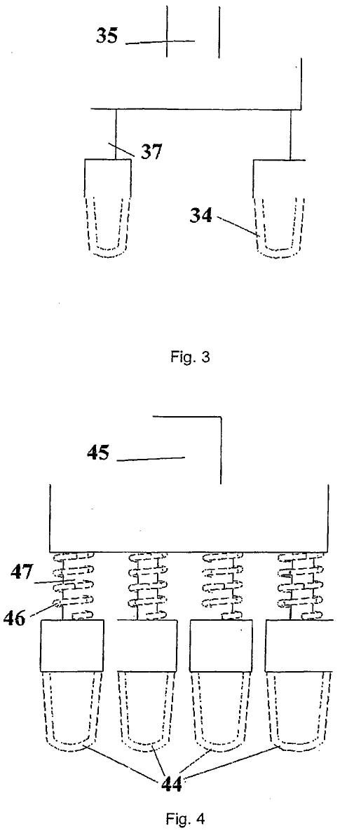

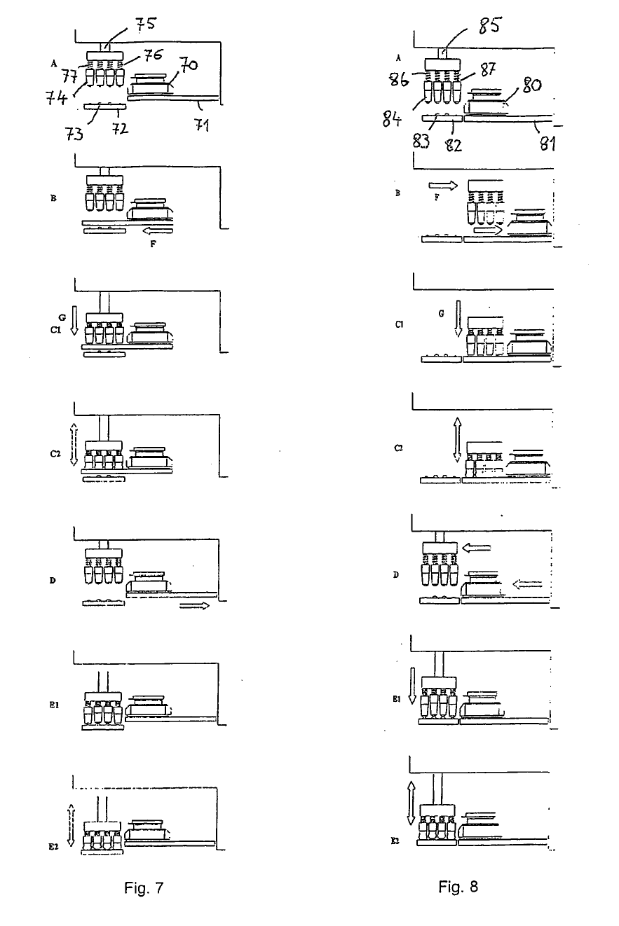

The print head is of the linear pad printing type, with open inking or closed ink cartridge. The mode of operation of said print head is illustrated in the side view of FIG. 7. There are various types of linear pad printing. FIG. 7 shows the closed ink cartridge 70, and also the pad system comprising the primary guide 75, the secondary guide 76 and the pad 74, which pad is solid, as shown in e.g. FIG. 2, or is hollow, as shown in FIGS. 3 and 4, the cliché plate 71 and the piece holder 72 in its most general form with the product 73 to be printed.

The mode of operation of the system is described below. The printing unit operates with a double guide for the pad. In addition to the primary guide for the main movement of the pad—movement from and to cliché plate and product and roll-over movement of pad on product (printing)—an additional secondary guide acts as a buffer in order to compensate for the significant variations between products, in particular as regards shape and product dimensions.

According to FIG. 2, the pad can move individually relative to a fixed base which is fixed on the primary pad guide. By means of spring action the pad is subjected to a force in a direction opposite to the direction for taking up and depositing the ink.

In addition to the additional secondary guide, a hollow pad can also be used as the buffer for compensating for the product variation. Apart from that, the hollow pad also serves to reduce the pressure force required during the process of rolling over the product, as will emerge below.

The method according to FIG. 5 is as follows. Adapted to the effective variation in shape and dimensions of the product, the piece holder can contribute to ensure that the position of the product surface to be printed remains unchanged as far as possible relative to the printing unit. In order to achieve this, use is made of a system in which the products can be moved by means of an individual guide according to a movement direction indicated by means of arrow H until the products are pressed with the side to be printed against a mask. Said mask retains the product in so far as it is larger than an opening through which the product can be printed in the desired place. As a result of this, the product surface to be printed is taken as far as possible to the same height relative to the printing unit. The product variation is partly compensated for in this way.

The method according to FIG. 7 is as follows. Position A is the starting position, also a rest position. The cliché plate 71 is not inked and the pad 74 is situated in its rest position, away from the cliché plate 71 and product 73. The secondary guide 76 and/or hollow pad are also situated in their rest positions.

In a first phase ink is applied to the flat cliché plate 71. According to various methods of execution, inter alia, the ink cartridge 70 can be moved over the plate 71 in this case, or, conversely, the plate can be moved relative to the stationary ink cartridge. Irrespective of the method, the situation after the inking is that ink is applied according to a particular pattern or image to the plate 71.

From position A the pad 74 is then removed towards the cliché 71 into position B according to a direction of movement indicated by arrow F by means of the primary guide 75, in order to take up ink from the cliché 71. While the ink is being taken up the additional secondary pad guide 76 partly buffers the movement of the pad 74 by means of the primary guide 75. This makes the process of uptake of the ink easier to control.

The buffering capacity of the additional secondary pad guide 76 is of essential importance as regards the effect during uptake of the ink, said buffering capacity being essential for optimum printing of the products concerned here. A hollow pad can influence the uptake process in an analogous way during uptake of the ink. The force necessary for uptake of an image in particular will thus be lower than it is in the case of a solid pad.

After this ink uptake in position B, the pad returns to position A.

After the path between pad and product has been cleared according to the primary guide 75, the pad is moved according to said guide to position C and in the process deposits the image that it has taken up on the product. During this process the movement of the pad 74 by means of the primary guide 75 can be divided into various phases. In a first phase the pad moves from position A to position D, the first contact between pad and product.

Position D is dependent upon the effective product characteristics such as shape and dimensions of the product. The image is deposited on the product during movement from position D to position C and back to position D. As a result of the difference in distance between position C and position D for different products, if no buffer is present, the pressure between pad and product can become so great that this gives rise to adverse effects while the pad is rolling over the product, and leads to deformation of the product. However, in this case the secondary guide 76 acts as such a buffer. This means that the maximum pressure force on the product is limited, and the efficiency of the roll-over process retained.

Finally, the pad is moved back to its initial position A.

An alternative method consists in making specific measurements of the product characteristics first. Automated systems based on cameras can be used for this purpose. Product characteristics which could possibly be measured include the individual product dimensions. On the basis of the measured characteristics, the printing parameters of the printing unit can then be adapted to the requirements. The automated system of measuring the characteristics and a processing unit which makes the connection between the measured characteristics and the corresponding printing parameters for the printing unit are important in the case of this process.

The following experiments were carried out on machines which carry out a method according to conventional linear pad printing, these experiments illustrating the measures taken according to the invention and the advantages associated with them. In these experiments retaining the quality of the product was the most important evaluation criterion applied, namely reproducible quality of the printing and no permanent product deformation.

### Experiment 1

For a first experiment the products to be printed consisted of a fruit of the dried type, in particular a raisin or a nut, coated in chocolate. The printed image consisted of a monochrome logo.

From a rough analysis of the series it emerged that as a result of the natural variation in the dimensions of the fruits and the variation in the chocolate coating the external dimensions of the products to be printed varied widely. Relatively great deviations of 50% and more in three spatial directions were established physically. The shape of the objects to be printed was also subject to great variability: spherical, oval, cylindrical, conical.

Optimum printing results were obtained by adapting the machine parameters, in particular the deposit depth of the image on the product, to the individual characteristics such as dimensions of the products to be printed. As a result of the great variation in the dimensions, it was found that a great variation was necessary on this parameter of deposit depth for this purpose.

It was striking that the least overloading as a result of too great a pressure force damaged the products irrevocably. In order to keep the product quality within the tolerances after the printing, it was found that a correct pressure buildup was absolutely essential for transfer of the image to the product: the correct speed of rolling over the object, taking into account the maximum tolerated pressure force on the product.

### Experiment 2

For a second experiment the objects to be printed consisted of porcelain plates. The printed image was a monochrome pattern which had to be printed up to the edge of the plate.

During the print testing it was found that there was a significant variation in the characteristics of the plates, such as diameter and slope from the edge of the plate, with the result that it was impossible to print the image up to the edge of all plates using the conventional method of pad printing, in particular with a cliché and pad and a fixed setting of the uptake depth and deposit depth.

The dimensions of the pattern to be printed had to be adapted in the optimum way to the dimensions of the individual plates.

It should be understood that the operation described above is merely for the purpose of illustration and is in no way to be considered as limiting for the scope of protection of this application.

It should therefore be understood that the device and the method described here can be applied not only to printing of relatively small-scale products of the confectionery or pharmaceutical tablets type, but also possibly to larger, fragile products such as porcelain ware etc.

A further addition to the device is a control system for checking the products after printing. In this case both the product itself and the printing can be controlled. The result of this control can then be applied in order to take out of production products not meeting the quality requirements set. Several systems can be used for this, the sole objective being to remove the rejected products.

1-24. (canceled)

25. A device for linear pad printing products with significant variations between them by means of a linear pad, comprising at least one pad with a primary guide provided for the main movement of the pad, which provides for a movement function, wherein said device comprises at least one secondary guide as buffer element for buffering the differences in effective deposit depth between the individual products to be printed, wherein said at least one secondary guide is arranged axially with respect to said pad and outwardly thereto so as to act thereon.

26. A device according to claim 25, wherein said at least one secondary guide is provided for buffering the differences in effective deposit depth between a plurality of individual products to be printed which consist of confectionery, including sugared almonds and chocolates, and/or pharmaceutical tablets selectively and/or individual fragile products including porcelain ware.

27. A device according to claim 25, wherein each said secondary buffer element is formed by elastic elements, preferably of the spring type, which are arranged substantially axially relative to the movement axis of the pad.

28. A device accordingly to claim 25, wherein it comprises a piece holder for receiving the products to be printed, wherein said piece holder is provided with apertures provided therefore, wherein the products to be printed can be taken up, wherein the position and the orientation of the product relative to the printing unit can be brought in correspondence with the one which is necessary for printing the image at the appropriate position on the product.

29. A device according to claim 25, wherein said at least one pad is solid.

30. A device according to claim 25, wherein said at least one pad is hollow.

31. A device according to claim 25, wherein it comprises a set of multiple printing pads for each primary guide in said device by means whereof various products can be printed simultaneously with the buffering action of said secondary buffer elements.

32. A device according to claim 25, wherein it comprises for each printing unit a set of primary and respectively secondary elements, which are arranged by respective pairs, wherein said secondary elements are each connected directly to a corresponding pad and which are disposed according to the movement axis thereof.

33. A device according to claim 25, wherein it is integrated in an automatic or manual machine selectively.

34. A device according to claim 25, wherein it is provided with printing means for printing products with various colors.

35. A device according to claim 25, wherein it is provided with printing means for printing products on various sides thereof.

36. A method for linear pad printing products with significant variations between them by means of a pad, wherein printing material is applied on a cliché according to a determined pattern, wherein a pad and a cliché are brought in mutual contact (B) from a rest position (A) by means of a primary guide, wherein the printing material is taken up by the pad of the cliché, and in that when taking up said printing material, the additional secondary guide buffers the contact between the pad and the cliché, after which the pad is moved in a deposit position (C), wherein the image taken up by the pad is deposited on the product to be printed, wherein said secondary guide elements axially buffer the contact between the pad and the products to be printed and after which said pad is moved back to its rest position (A).

37. A method for printing products with mutual significant variations, by means of a pad, according to claim 36, wherein printing material is applied on a cliché according to a determined pattern, wherein the parameters of the products to be printed are measured previously, such as in particular the dimensions of the products.

38. A method according to claim 36, wherein said at least one secondary guide buffers the differences in effective deposit depth between a plurality of individual products to be printed which consist of confectionery including sugared almonds and chocolates and/or pharmaceutical tablets selectively and/or individual fragile products including porcelain ware.

39. A method according to claim 36, wherein said method is performed by a device comprising at least one pad with a primary guide provided for the main movement of the pad, which provides for a movement function, wherein said device comprises at least one secondary guide as buffer element for buffering the differences in effective deposit depth between the individual products to be printed, wherein said at least one secondary guide is arranged axially with respect to said pad and outwardly thereto so as to act thereon.

40. A method according to claim 36, wherein a plurality of products are printed substantially simultaneously.

41. A method according to claim 36, wherein the printing parameters of the printing unit are adapted to the requirements on the basis of the measured parameters by means of a processing unit provided therefor, which establishes the link between the measured parameters and the related printing parameters for the printing unit.

42. A method according to claim 37, wherein said product parameters are measured by means of an automated system on the basis of cameras provided therefor.

43. A method according to claim 36, wherein the products are checked after printing by means of a control system provided therefor, wherein the printed product as such and/or the printing itself are checked.

44. A method according to claim 36, wherein the taking up and deposit depth, and the shape and the effective hardness of the pad are set individually as parameters, wherein an optimum printing is carried out on an individual product basis.

45. A method according to claim 36, wherein conditioning of the product to be printed in the environment is proposed, in particular the piece holder, with regard to conditioning parameters, such as temperature, pressure and humidity.

46. A method accordingly to claim 36, wherein conditioning of the substance to be printed, such as ink, chocolate, and the like is proposed with regard to the conditioning parameters of temperature, viscosity and color in order to keep the printing quality substantially constant.

47. A method according to claim 36, wherein the printing of the product is carried out by means of a plurality of colors.

48. A method according to claim 36, wherein the printing of the product is carried out on a plurality of sides thereof.
